(19) United States
(12) Patent Application Publication
(10) Pub. No.: US 2025/0226505 A1
(43) Pub. Date: Jul. 10, 2025

(54) BATTERY PACK

(71) Applicant: TOYOTA JIDOSHA KABUSHIKI KAISHA, Toyota-shi Aichi-ken (JP)

(72) Inventors: Hiroshi OTAKE, Toyota-shi Aichi-ken (JP); Kotaro HORIGUCHI, Nagoya-shi Aichi-ken (JP); Hiroaki SHIMAZAKI, Seto-shi Aichi-ken (JP)

(73) Assignee: TOYOTA JIDOSHA KABUSHIKI KAISHA, Toyota-shi Aichi-ken (JP)

(21) Appl. No.: 19/013,052

(22) Filed: Jan. 8, 2025

(30) Foreign Application Priority Data
Jan. 10, 2024 (JP) 2024-001648

(51) Int. Cl. H01M 50/242; H01M 50/249; H01M 50/264; H01M 50/505

(52) U.S. Cl. CPC H01M 50/242; H01M 50/249; H01M 50/264; H01M 50/505

(57) ABSTRACT

The protectability of battery module is enhanced. A battery pack includes: a case; a battery module including a bus bar at side-parts thereof in a lateral direction; and a battery fastening member including a member main body extending in a longitudinal direction and a pair of fastening parts for fixing the battery module to both edge-parts of the member main body in the longitudinal direction and arranged on the side-parts side of the battery module in the lateral direction, in which the battery fastening member has an upper edge thereof arranged at a position higher than a lower edge of the bus bar, at least a part of the battery fastening member being thinly formed in a vertical direction, and the thinly formed part of the battery fastening member being arranged at a position lower than the lower edge of the bus bar.

### CROSS REFERENCE TO RELATED APPLICATIONS

This application is based upon and claims the benefit of priority from Japanese patent application No. 2024-001648, filed on Jan. 10, 2024, the disclosure of which is incorporated herein in its entirety by reference.

### BACKGROUND

The present disclosure relates to a battery pack.

In recent years, battery packs have been used in BEV: Battery Electric Vehicle, etc. Shock absorber is used for battery packs because there is a possibility that the battery packs are subject to external shocks. Patent Literature 1 discloses an external shock absorber which can be manufactured at a low cost and can protect battery packs from shocks.

Patent Literature 1: Japanese Unexamined Patent Application Publication No. 2013-062092

### SUMMARY

When an impact is applied to a battery pack of a vehicle from outside of the vehicle due to collision of the vehicle or the like, and a load is applied especially to the side-surface side of the battery pack, in some cases a load is also applied to a battery module stored inside the battery pack or a bus bar provided in the side-part of the battery module. Therefore, in order to ensure further safety even when an impact is applied to a battery back of a vehicle from outside of the vehicle, there is a desire to enhance the protectability for the stored battery module.

The present disclosure has been made in view of the above-described problem, and it is an object of the present disclosure to provide a battery pack having an enhanced protectability for the stored battery module.

According to the present disclosure, a battery pack includes:
a case;
a battery module including a bus bar at a side-surface thereof in a lateral direction; and
a battery fastening member including a member main body extending in a longitudinal direction and a pair of fastening parts for fixing the battery module to both edge-parts of the member main body in the longitudinal direction and arranged in the lateral direction on the side-surface side,
in which the battery fastening member has an upper edge thereof arranged at a position higher than a lower edge of the bus bar, at least a part of the battery fastening member being thinly formed in a vertical direction, and the thinly formed part being arranged at a position lower than the lower edge of the bus bar.

Thus, due to the movement of a bus bar provided in a side-part of a battery module, it is possible to prevent a load from being applied to the battery module when a load is applied to the battery pack.

According to the present disclosure, it is possible to provide a battery pack having an enhanced protectability for a stored battery module.

The above and other objects, features and advantages of the present disclosure will become more fully understood from the detailed description given hereinbelow and the accompanying drawings.

### BRIEF DESCRIPTION OF DRAWINGS

FIG. 1 is a top view of a battery pack according to the present disclosure;

FIG. 2 is an enlarged top view of a main part of a battery pack according to the present disclosure;

FIG. 3 is an enlarged top view of a main part of a battery pack according to the present disclosure;

FIG. 4 is an enlarged side view of a main part of a battery pack according to the present disclosure;

FIG. 5 is a perspective view of a battery fastening member according to the present disclosure; and

FIG. 6 is a top view of a battery pack according to the present disclosure.

### DESCRIPTION OF EMBODIMENTS

### First Embodiment

Hereinafter, a specific embodiment to which the present disclosure is applied will be described in detail with reference to the drawings. However, the present disclosure is not limited to the following embodiments. In order to clarify the description, the following description and drawings are simplified where appropriate.

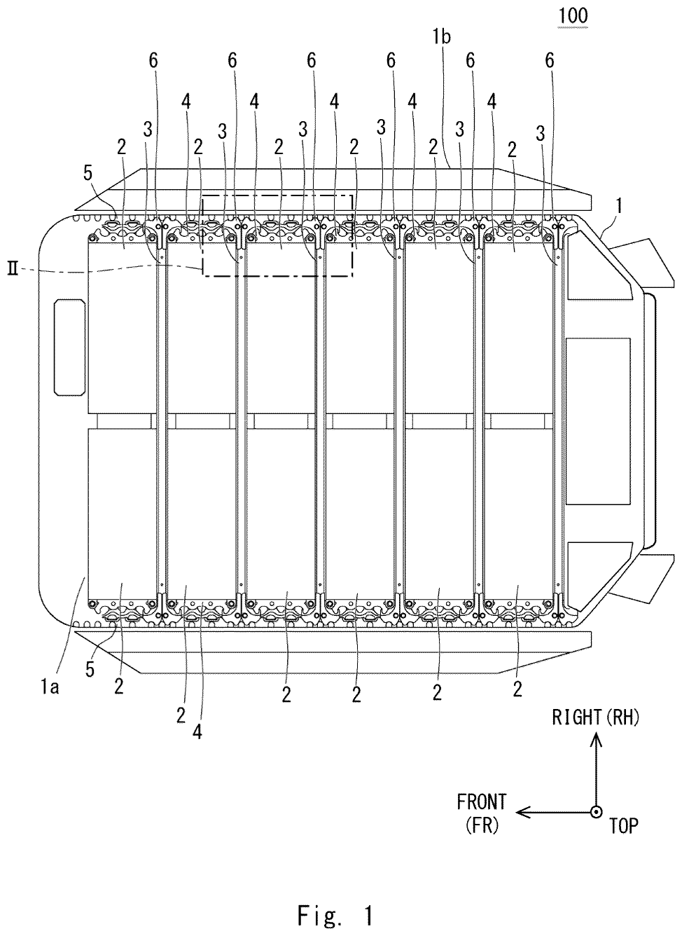

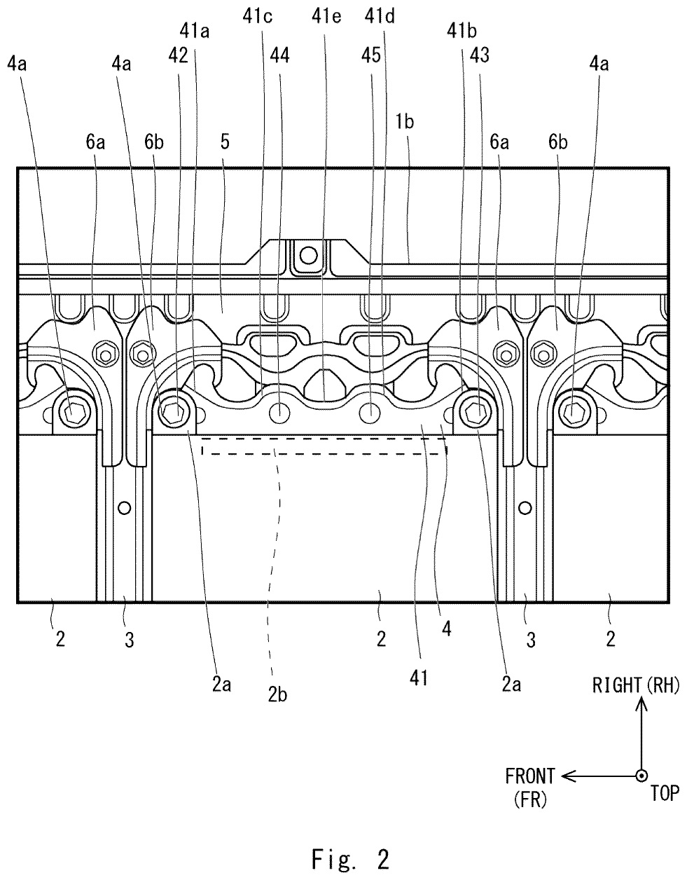

Hereinafter, a battery pack according to the present embodiment will be described with reference to the drawings. FIG. 1 is a top view of a battery pack according to the present disclosure. FIG. 2 is an enlarged top view of a main part of the battery pack shown in FIG. 1.

Hereinafter, the left direction in FIGS. 1 and 2 is defined as the front direction (Fr direction) with respect to a battery pack 100 when it is mounted on a vehicle, and the upper direction in FIGS. 1 and 2 is defined as the right-hand direction (RH direction) with respect to the battery pack 100 when it is mounted on a vehicle.

As shown in FIGS. 1 and 2, the battery pack 100 includes a case 1, a plurality of battery modules 2, a plurality of lateral direction structural members 3, a plurality of battery fastening members 4, a plurality of longitudinal direction structural members 5, and a plurality of load transfer members 6 which include a plurality of load transfer members 6a and 6b.

Hereinafter, the lateral direction of the battery pack 100 when it being mounted on the vehicle is sometimes referred to as a side-part direction. For both the longitudinal direction and the lateral direction, the direction toward the center of the battery pack 100 is defined as the inside, and the opposite direction is defined as the outer side. For example, the direction in which the battery module 2 is provided in the case 1 is defined as the inside in the longitudinal direction. Conversely, the direction in which the lateral direction structural members 3 are provided continuously in the longitudinal direction so as to sandwich the battery module 2 is defined as the outer side in the longitudinal direction.

The case 1 is a case that houses the battery module 2, a plurality of the lateral direction structural members 3, a plurality of the battery fastening members 4, and a plurality of the longitudinal direction structural members 5. The battery pack 100 includes a plurality of the battery modules 2, a plurality of the lateral direction structural members 3, a plurality of the battery fastening members 4, a plurality of the longitudinal direction structural members 5, and a plurality of the load transfer members 6. The case 1 has a bottom surface 1a. Assume that regarding the external form of the case 1, the edge-part in the lateral direction is a side-part 1b of the case 1.

More specifically, the lateral direction structural members 3, the battery fastening members 4, and the longitudinal direction structural members 5 are respectively provided on the bottom surface 1a. The battery module 2 is, for example, a lithium ion battery or the like.

The battery module 2 has a rectangular shape extending in the longitudinal direction and the lateral direction. Here, the battery module 2 is configured by stacking a plurality of battery cells in a vertical direction. The battery module 2 is arranged on the inside in the longitudinal direction between two adjoining lateral direction structural members 3 among the plurality of the lateral direction structural members 3.

The battery module 2 has a connection part 2a which protrudes from a side part of the battery module 2. The connection part 2a is fixed to the case 1 via a fastening part 4a of the battery fastening member 4 described later, whereby the battery module 2 is fixed to the case 1. Here, it is assumed that the connection part 2a is provided with a hole which penetrates in the vertical direction and can be bolted.

In the battery module 2, the two connection parts 2a which protrude from the right side-part of the battery module 2 in the right-hand direction are provided on the front side and the rear side, respectively, and the same applies to the left side-part of the battery module 2. That is, the connection part 2a of the battery module 2 is formed so as to protrude from each corner part of the rectangular battery module 2 to the side-part 1b side of the adjacent case 1.

In the battery module 2, a bus bar 2b is arranged on a side-part side where the connection part 2a is provided. The bus bar 2b electrically connects a plurality of battery cells stacked in the vertical direction. In the longitudinal direction of the right side-part of the battery module 2, the bus bar 2b is arranged so as to be sandwiched between the two connection parts 2a in the longitudinal direction.

In the following description, in order to simplify the description of the configuration of the battery pack 100, the description will be made focusing on the vicinity of the right side-part of the battery module 2, but the same configuration can be made for the vicinity of the left side-part of the battery module 2.

As shown in FIG. 2, the lateral direction structural members 3 is a structural member (inner cross) in a battery pack, and is installed on the bottom surface 1a at a predetermined height and has a configuration extending in the lateral direction. Further, the plurality of the lateral direction structural members 3 are continuously provided in the longitudinal direction at approximately equal intervals and separated from each other by a predetermined distance.

Each longitudinal direction structural member 5 is a structural member in a battery pack, and is provided in the vicinity of the side surface of the case 1. Each longitudinal direction structural members 5 is installed on the bottom surface 1a at a predetermined height and has a configuration extending in the longitudinal direction. Each longitudinal direction structural member 5 may be arranged at a position other than the vicinity of the side-part 1b of the case 1, but the description will be given only for the case in which the structural members 5 are arranged in the vicinity of the right and the left side-parts 1b of the case 1.

Here, the plurality of the lateral direction structural members 3 extend in the lateral direction and are arranged so that the edge-parts thereof abuts the longitudinal direction structural member 5 and are orthogonal to the longitudinal direction structural member 5.

The battery fastening member 4 is arranged between the side-parts in the lateral direction of the battery module 2 and the longitudinal direction structural members 5. The battery fastening member 4 has a plurality of fastening parts 42, 43 which are holes used for fixing the battery module 2 in a member main body 41 and enable a bolt to penetrate in the vertical direction, and a plurality of conveyor holes 44, 45 which are used for transportation. The conveyor holes 44, 45 are holes used when a battery fastening member 4 is picked up and transported by an automatic machine in manufacturing the case 1.

More specifically, the member main body 41 extends in the longitudinal direction, and has a predetermined width in the lateral direction shorter than the longitudinal direction, and is thinly formed in the vertical direction compared to the thickness in the lateral direction. The battery fastening member 4 has a pair of the fastening parts 42, 43 formed in the vicinity of both edge-parts in the longitudinal direction, and a pair of the conveyor holes 44, 45 formed on the inside in the longitudinal direction from the pair of the fastening parts 42, 43. In the description hereinafter, the fastening parts may be described as a first fastening part 42 and a second fastening part 43, and the conveyor holes may be described as a first conveyor hole 44 and a second conveyor hole 45.

Typically, as shown in FIG. 2, the fastening parts 42, 43 and the conveyor holes 44, 45 are arranged at substantially the same positions in the lateral direction and continuously arranged in the longitudinal direction. That is, in the member main body 41, the fastening part 42, the conveyor hole 44, the conveyor hole 45, and the fastening part 43 are arranged in this order from the front side. FIG. 2 shows a state in which holes other than these holes are formed in the vicinity of the fastening parts 42, 43 in the member main body 41 of the battery fastening member 4.

Here, in the member main body 41, at the position where the fastening parts 42, 43 and the conveyor holes 44, 45 are formed, a wide part is formed, which is a part widened in the right-hand direction which is a direction on the side opposite to the battery module 2.

Here, in the member main body 41, a part where the first fastening part 42 is widened is defined as a first wide part 41a, a part where the second fastening part 43 is widened is defined as a second wide part 41b, a part where the first conveyor hole 44 is formed is widened is defined as a third wide part 41c, and a part where the second conveyor hole 45 is formed is widened is defined as a fourth wide part 41d.

The first wide part 41a and the second wide part 41b are formed longer in the right-hand direction than the third wide part 41c and the fourth wide part 41d.

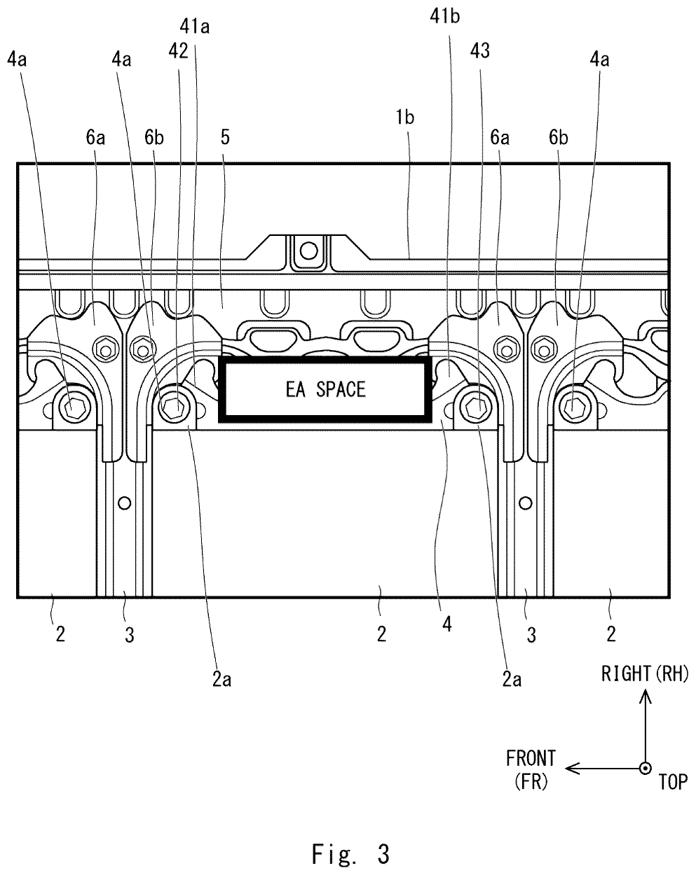

Here, as shown in FIG. 3, the fastening parts 42, 43 are arranged closer to the outer side in the longitudinal direction. Specifically, the fastening parts 42, 43, which are connected to the connection part 2a of the battery module 2, can be arranged in the vicinity of the edge-part in the longitudinal direction of the main body of the battery module 2 so as to be as close to the outer side as possible within a range not being outside the edge-parts in the longitudinal direction of the main body of the battery module 2.

Thus, as shown in FIG. 3, in the top view, an EA (energy absorption) space set surrounded by the right edge-part of the first wide part 41a, the right edge-part of the second wide part 41b, and the position immediately before the line segments extending in the lateral direction in the battery module 2 side direction reach the battery module 2 can be secured as wide as possible.

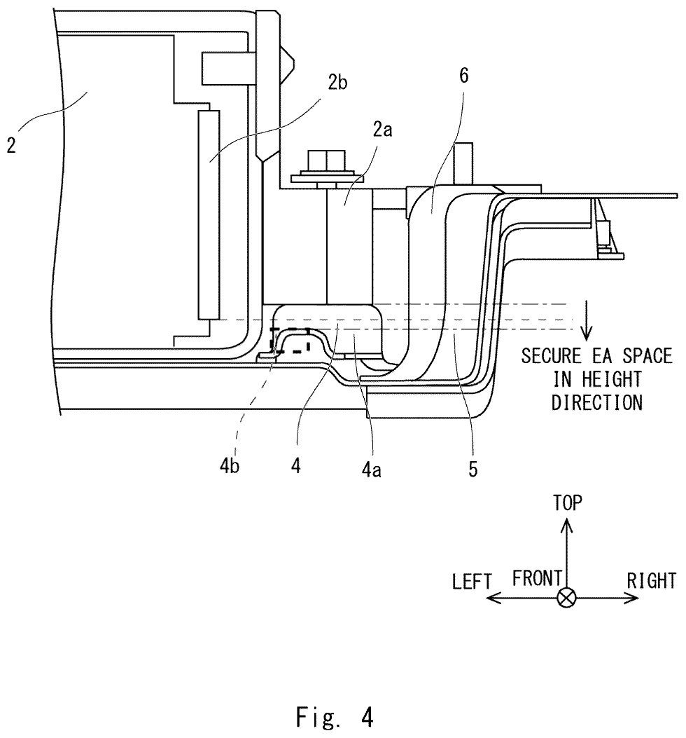

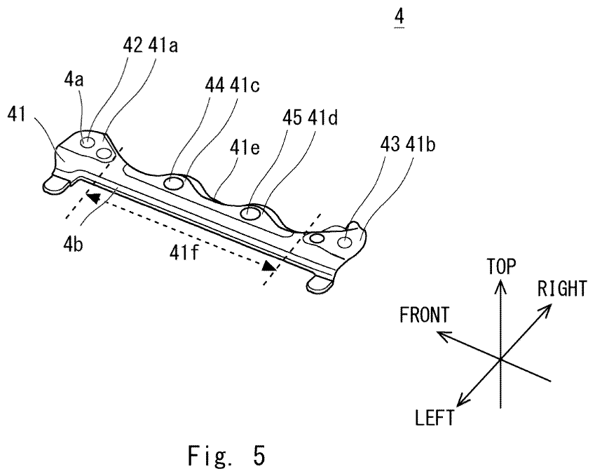

Furthermore, the member main body 41 is formed such that a left edge-part 4b on the left side in the lateral direction adjacent to the side-part of the battery module 2 is thinly formed in the height direction and passes through a low position at least between the first wide part 41a and the second wide part 41b. Here, FIG. 4 is a view showing a main part of a battery pack as viewed from sideward direction, and FIG. 5 is a perspective view of the member main body 41 of the battery fastening member 4.

Specifically, as shown in FIG. 4, in an ordinary arrangement of the battery module 2 and the battery fastening member 4, the upper edge of the member main body 41 of the battery fastening member 4 is arranged at a position slightly higher than the lower edge of the bus bar 2b provided in the battery module 2.

Here, as shown in FIG. 5, at least a portion of the left edge-part 4b on the battery module 2 side of the battery fastening member 4 is thinly formed in the vertical direction, and the thinly formed portion is arranged at a position lower than the lower edge of the bus bar 2b.

Here, in a bridging part 41f between the first wide part 41a and the second wide part 41b, the left edge-part 4b on the left side is thinly formed in the vertical direction and is formed so as to pass through only a low position in the vertical direction. When the battery module 2 and the battery fastening member 4 are arranged in the battery pack 100, the bridging part 41f which is thinly formed in the vertical direction is arranged so as to be lower than the lower edge of the bus bar 2b when compared in the vertical direction.

The bridging part 41f is a portion in the longitudinal direction between the inner edge-part of the first wide part 41a and the inner edge-part of the second wide part 41b.

As shown in FIG. 4, the left edge-part 4b which is thinly formed in the vertical direction of the battery fastening member 4 is not limited to the bridging part 41f, and may be provided in a range other than the bridging part 41f, such as the entire left side of the battery module 2 side. That is, the left edge-part 4b having a thin shape can be provided in the vertical direction as a whole longitudinal direction of the battery fastening member 4. In the member main body 41 of the battery fastening member 4, the width in the lateral direction of the edge-part 4b can be arbitrarily changed.

Further, in the battery fastening member 4, the third wide part 41c is arranged in the front of the central part in the longitudinal direction of the battery fastening member 4, and the fourth wide part 41d is arranged in rear of the central part in the longitudinal direction of the battery fastening member 4. That is, a constricted part 41e is formed between the third wide part 41c and the fourth wide part 41d so that a right part thereof is recessed on the battery module 2 side so as to narrow the width of the member main body 41 in the lateral direction.

In other words, the constricted part 41e is a short part formed in the lateral direction in a shape recessed on the battery module 2 side between the wide parts 41c, 41d where the pair of the conveyor holes 44, 45 are formed in the longitudinal direction and on the side opposite to the battery module 2 in the lateral direction.

Next, a function of protecting the battery module 2 when an external force is applied to the case 1 of the battery pack 100 having the above-described configuration will be described.

First, as shown in FIG. 3, since the fastening parts 42, 43 are located closer to the outer side in the longitudinal direction, a large EA space is secured. Thus, even when an object collides on the right side-part 1b of the battery pack 100 and a load is applied toward the inside of the battery pack 100, energy absorption can be completed before a load is applied to the battery module 2.

Also, in order to secure a large EA space in this way, since the distance between the longitudinal direction of the connection part 2a provided in the battery module 2 needs to be increased, the battery module 2 needs to be formed longer in the longitudinal direction.

Therefore, in the battery module 2, in consideration of maintaining the same battery capacity, the length thereof in the lateral direction can be shortened in accordance with the elongation thereof in the longitudinal direction. Therefore, the size of the battery pack 100 in the lateral direction can be reduced in accordance with the size of the battery module 2 in the lateral direction.

The member main body 41 of the battery fastening member 4 includes the constricted part 41e. Thus, by forming the central portion in the longitudinal direction of the member main body 41 to have a constricted shape, when an external force is applied to the case 1 and a part of the longitudinal direction structural members 5 is bent inward in the lateral direction, it is possible to secure a large EA space in the central portion in the longitudinal direction that is closest to the side surface of the battery module 2.

When the battery module 2 and the battery fastening member 4 are arranged in the battery pack 100, the bridging part 41f of the battery fastening member 4 is arranged so as to be lower than the lower edge of the bus bar 2b of the battery module 2.

Therefore, even when a load is applied from the right side-part 1b of the case 1 and the battery fastening member 4 is pushed to the left side, which is the battery module 2 side, the bridging part 41f is apt to enter the lower edge of the bus bar 2b.

This makes it possible to increase the distance until the battery fastening member 4 presses the bus bar 2b. Accordingly, when a load caused by an external force is applied on the battery pack 100, damage to the bus bar 2b caused by the battery fastening member 4 pressing the bus bar 2b can be reduced.

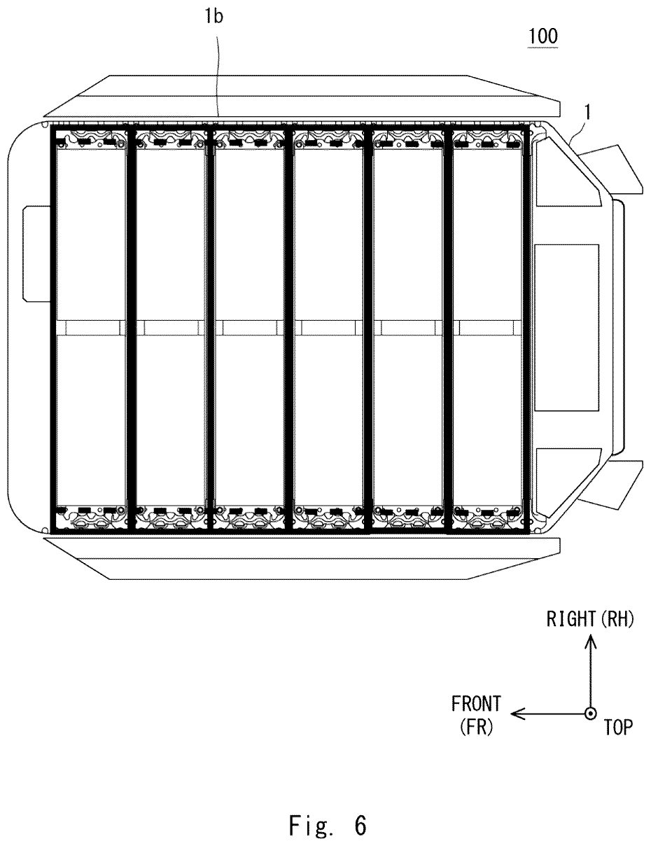

FIG. 6 is a top view of the battery pack 100, in which the lateral direction structural members 3 and longitudinal direction structural members 5 are illustrated by solid lines, and the battery fastening member 4 is illustrated by dashed lines.

As shown in FIG. 6, for example, in the vicinity of the right side-part 1b of the battery pack 100, a plurality of the battery fastening members 4 are arranged in a straight line in the longitudinal direction. Here, since the battery fastening members 4 are configured to extend in the longitudinal direction, it can be considered that a group of the plurality of the battery fastening members 4 and the longitudinal direction structural members 5 are arranged in parallel with each other with a predetermined distance from each other.

Here, the battery fastening member 4 can be fixed while being connected to the lateral direction structural members 3 on the inner side with respect to the longitudinal direction structural members 5.

By fixing the battery fastening member 4 and the lateral direction structural members 3 in this way, the case 1 can be supported in the vicinity of the side-part 1b of the case 1 using both the battery fastening member 4 and longitudinal direction structural members 5 as supporting members extending in the longitudinal direction. Therefore, the rigidity of the battery pack 100 can be enhanced.

In summary, when a load is applied from the side-part 1b of the case 1 with the battery fastening member 4 arranged at the side-part of the battery module 2, it is possible to gain a distance until the battery fastening member 4 moves and presses the bus bar 2b, and even when the longitudinal direction structural members 5 are bent inward in the lateral direction, it is possible to secure an EA space for absorbing energy until the bent longitudinal direction structural members 5 or the like press the battery module 2.

Since the battery fastening members 4 can function as a frame of the case 1 by being connected to the lateral direction structural members 3, the rigidity of the battery pack 100 can be increased.

Accordingly, the battery pack 100 can enhance the protectability for the stored the battery module 2.

It should be noted that present disclosure is not limited to the above example embodiments and may be changed as appropriate to the extent that it does not deviate from the gist of the present disclosure. Note that the aforementioned description is appropriately shortened and simplified where appropriate for the sake of clarification of the explanation, one skilled in the art can easily make change, addition, or modification to each element/component in the embodiments within the scope of the present disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A battery pack comprising:
a case;
a battery module including a bus bar at side-parts thereof in a lateral direction; and
a battery fastening member including a member main body extending in a longitudinal direction and a pair of fastening parts for fixing the battery module to both edge-parts of the member main body in the longitudinal direction and arranged in the lateral direction on the side-parts side of the battery module,
wherein the battery fastening member has an upper edge thereof arranged at a position higher than a lower edge of the bus bar, at least a part of the battery fastening member being thinly formed in a vertical direction, and the thinly formed part of the battery fastening member being arranged at a position lower than the lower edge of the bus bar.

2. The battery pack according to claim 1, wherein the member main body of the battery fastening member includes:
a plurality of wide parts formed to widen on a side opposite to the battery module at a part of the member main body where the pair of the fastening parts and a pair of conveyor holes are formed, the pair of the conveyor holes being formed on the inner side with respect to the pair of the fastening parts arranged in the longitudinal direction; and
a constricted part recessed on the battery module side between the wide parts in which the pair of the conveyor holes are formed in the longitudinal direction and on the side opposite to the battery module in the lateral direction.

3. The battery pack according to claim 2, wherein the wide parts of the member main body of the fastening member, in which the pair of the fastening parts are formed, are formed longer in the lateral direction than the wide parts in which the conveyor holes are formed.

4. The battery pack according to claim 1, wherein the fastening parts are arranged in a vicinity of the edge-parts in the longitudinal direction of the battery module.

5. The battery pack according to claim 1, further comprising:
a longitudinal direction structural member arranged in a vicinity of the side-parts of the case and extending in the longitudinal direction; and
a plurality of lateral direction structural members arranged orthogonal to the longitudinal direction structural member and extending in the lateral direction, edge-parts thereof abutting the longitudinal direction structural member,
wherein the battery fastening member is connected to the lateral direction structural member inside the longitudinal direction structural member in the lateral direction so as to be fixed thereto.
